(19) United States
(12) Patent Application Publication
(10) Pub. No.: US 2014/0095151 A1
(43) Pub. Date: Apr. 3, 2014

(54) EXPRESSION TRANSFORMATION APPARATUS, EXPRESSION TRANSFORMATION METHOD AND PROGRAM PRODUCT FOR EXPRESSION TRANSFORMATION

(71) Applicant: KABUSHIKI KAISHA TOSHIBA, Tokyo (JP)

(72) Inventors: Akiko Sakamoto, Kanagawa-ken (JP); Satoshi Kamatani, Kanagawa-ken (JP)

(73) Assignee: KABUSHIKI KAISHA TOSHIBA, Tokyo (JP)

(21) Appl. No.: 13/974,341

(22) Filed: Aug. 23, 2013

(30) Foreign Application Priority Data
Sep. 28, 2012 (JP) 2012-218784

(51) Int. Cl. G06F 17/22

(52) U.S. Cl. CPC G06F 17/2264
USPC 704/9

(57) ABSTRACT

According to one embodiment, an expression transformation apparatus includes a processor; an input unit configured to input a sentence of a speaker as a source expression; a detection unit configured to detect a speaker attribute representing a feature of the speaker; a normalization unit configured to transform the source expression to a normalization expression including an entry and a feature vector representing a grammatical function of the entry; an adjustment unit configured to adjust the speaker attribute to a relative speaker relationship between the speaker and another speaker, based on another speaker attribute of the other speaker; and a transformation unit configured to transform the normalization expression based on the relative speaker relationship.

### CROSS REFERENCE TO RELATED APPLICATION

This application is based upon and claims the benefit of priority from Japanese Patent Application No. 2012-218784, filed on Sep. 28, 2012; the entire contents of which are incorporated herein by reference.

### FIELD

Embodiments described herein relate generally to transform style of dialogue, on which a plurality of speakers appear, according to the other speaker and scene of the dialogue.

### BACKGROUND

A speech dialogue apparatus inputs a question sentence spoken by a user and generates an answer sentence to the user. The apparatus extracts a type of date expression from the question sentence, selects the same type of date expression for the answer sentence and outputs the answer sentence according to the same type of date expression.

In a speech translation machine, if a speaker is a male, the machine translates to a masculine-expression and outputs the masculine-expression according to a masculine-voice. If a speaker is a female, the machine translates to a feminine-expression and outputs the feminine-expression according to a feminine-voice.

In Social Networking Services (SNS), if speech dialogue apparatuses and speech translation machines output in the same language and the same style of expression, the dialogues and the speech translations become uniform in the same expression, because of not being reflected in speaker gender. Therefore, it is difficult for listeners to distinguish which speakers are speaking.

In conventional technology, the technology can adjust expressions of a speaker according to an attribute of the speaker, but can not adjust the expressions based on the relationship between the speaker and listeners. The listeners include a person one who is speaking to the speaker.

For example, in case of describing a dialogue between a student with a casual way of talking and a professor with a formal way of talking, the conventional technology can not adjust features of their words and sentences according to the relationship between speakers and the dialogue scene. Therefore, the student's casual expressions can not be transformed to honorific expressions coordinating with the professor as a superior listener.

### BRIEF DESCRIPTION OF THE DRAWINGS

FIG. 1 shows an expression transformation apparatus and an attribute expression model constitution apparatus of one embodiment.

FIG. 2 shows a speaker attribute table for detecting a speaker attribute and an attribute characteristic word from a speaker profile information.

FIG. 3 shows a scene attribute table for detecting a scene attribute from dialogue scene information.

FIG. 4 shows an example of transforming an source expression into a normalization expression and its feature vector.

FIG. 5 shows an example of a morpheme dictionary and syntax information.

FIG. 6 shows an example of a normalization dictionary stored in an attribute expression model storage unit.

FIG. 7 shows rules for deciding statuses of each speaker according to the speakers attributes.

FIG. 8 shows a decision tree for deciding priority of attribute characteristic words according to a relationship between the speakers.

FIG. 9 illustrates a flowchart of avoiding overlap between the attribute characteristic words when each attribute characteristic word of the speakers is the same.

FIG. 10 illustrates a flow chart of applying an attribute expression model of an expression transformation apparatus.

FIGS. 11 to 13 show examples of applying attribute expression models.

FIG. 14 shows the case in which each attribute characteristic word of the speakers is the same and S906 in FIG. 9 is applied.

FIG. 15 illustrates a flow chart of the operation of an attribute expression model constitution apparatus.

FIG. 16 shows an example of the attribute expression model constitution apparatus.

FIG. 17 shows an example of an attribute expression model and an expansion attribute expression model.

### DETAILED DESCRIPTION

According to one embodiment, an expression transformation apparatus includes a processor; an input unit configured to input a sentence of a speaker as a source expression; a detection unit configured to detect a speaker attribute representing a feature of the speaker; a normalization unit configured to transform the source expression to a normalization expression including an entry and a feature vector representing a grammatical function of the entry; an adjustment unit configured to adjust the speaker attribute to a relative speaker relationship between the speaker and another speaker, based on another speaker attribute of the other speaker; and a transformation unit configured to transform the normalization expression based on the relative speaker relationship.

Various Embodiments will be described hereinafter with reference to the accompanying drawings.

### One Embodiment

An expression transformation apparatus of one embodiment transforms between Japanese expressions. But target languages are not limited Japanese. The apparatus can transform between any language expressions of the same or different languages/dialects. For example, common target languages can include one or more of Arabic, Chinese (Mandarin, Cantonese), English, Farsi, French, German, Hindi, Indonesian, Italian, Korean, Portuguese, Russian, and Spanish. Many more languages can be listed, but are not for brevity.

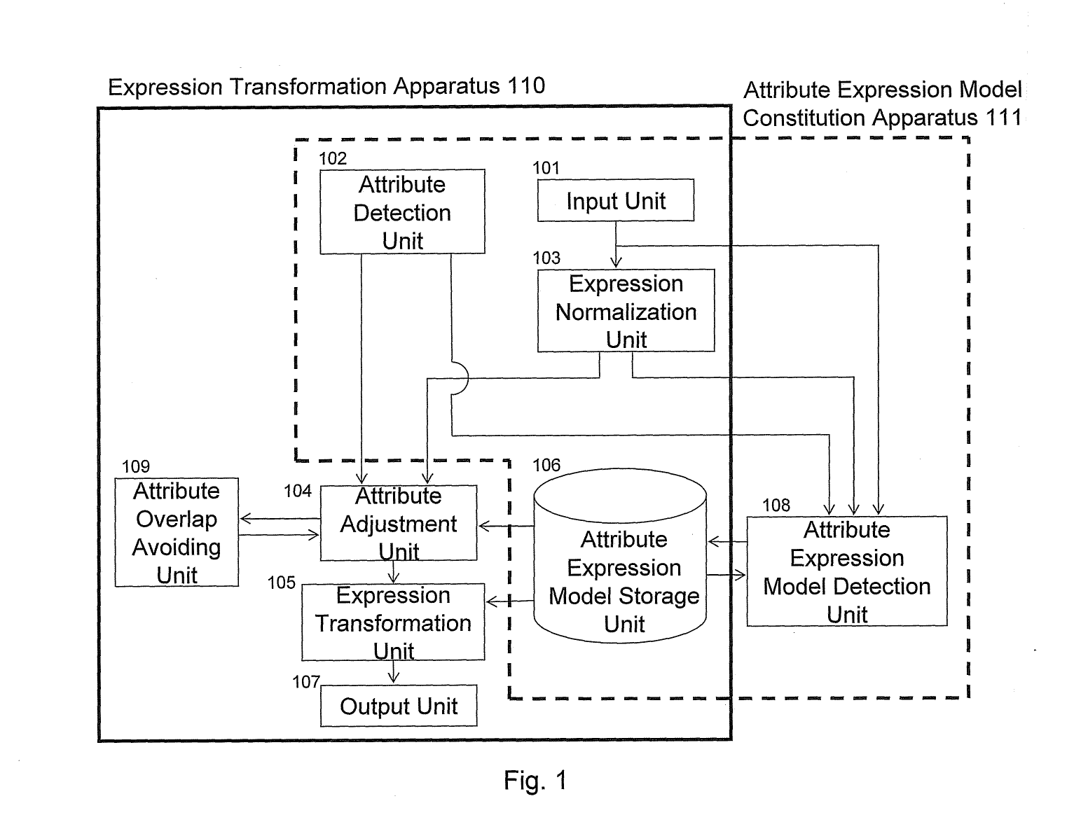

FIG. 1 shows an expression transformation apparatus 110 of one embodiment. The apparatus 110 includes an input unit 101, an attribute detection unit 102, an expression normalization unit 103, an attribute adjustment unit 104, an expression transformation unit 105, an attribute expression model storage unit 106, an output unit 107, an attribute expression model detection unit 108, and an attribute overlap avoiding unit 109.

The unit 101 inputs an expression spoken by a speaker as a source expression. The unit 101 can be various input devices inputting a natural language, a finger language and Braille, for example, a microphone, a keyboard, Optical Character Recognition (OCR), a recognition of character and trajectory handwritten by a pointing device for example pen-tablet, etc., a recognition of gesture detected by a camera, etc.

The unit 101 acquires the expression spoken by the speaker as text strings, and receives the expression as the source expression. For example, the unit 101 can input an expression “ [symbol] [symbol] ? (Did you read my e-mail?)” spoken by a speaker.

The unit 102 detects an attribute of a speaker (or user attribute) and an attribute of a dialogue scene.

(Method of Detecting Speaker Attributes)

The method checks speaker information (name, gender, age, location, occupation, hobby, language, etc.) from a predetermined speaker profile information by using rules of detecting an attribute, and detects one or more attributes describing the speaker.

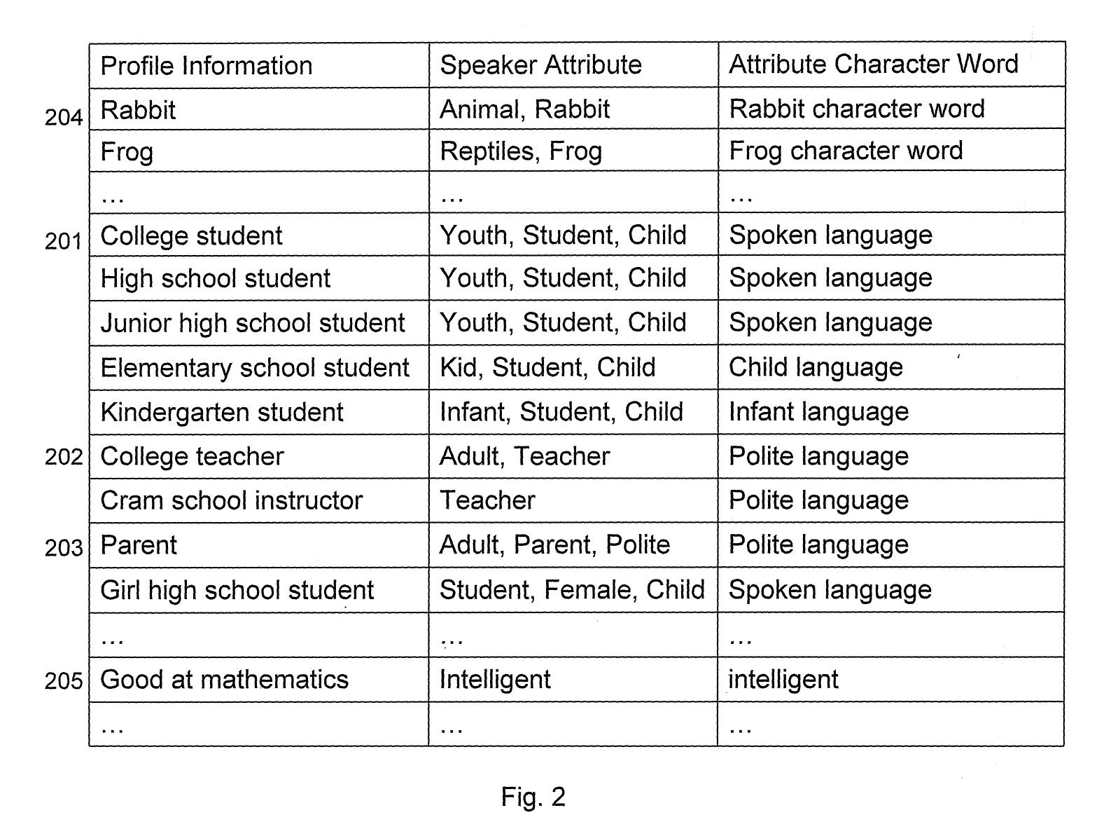

FIG. 2 shows a speaker attribute table for detecting a speaker attribute and an attribute characteristic word from speaker profile information. Row 201 shows that speaker attributes “Youth, Student, Child” and an attribute character word “Spoken language” is detected by the profile information “College student”. The attribute character word is a keyword that assigns most appropriate writing style and speaking style for the speaker.

In this embodiment, speaker attributes and an attribute character word are acquired by applying from the top to the bottom of the table shown in FIG. 2, and are set as high priority as acquiring fast.

(Method of Detecting a Scene Attribute)

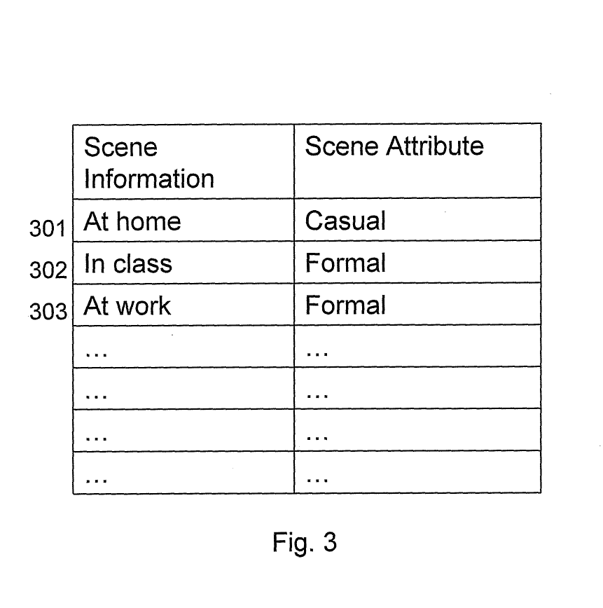

FIG. 3 shows a scene attribute table for detecting a scene attribute from dialogue scene information. When the unit 102 inputs scene information for example “At home” as a predetermined dialogue scene, the unit 102 detects a scene attribute “Casual” based on row 301.

The unit 103 executes natural language analysis of the source expression inputted by the unit 101, by using one or more of morphological analysis, syntax analysis, reference resolution, etc., and transforms the source language sentence into a normalization expression (or an entry) and its feature vector. The normalization expression represents an objective thing. The feature vector represents a speaker subjective recognition and speaking behavior to a proposition. In this embodiment, the feature vector is extracted as tense, aspect, mode, voice, etc., the unit 103 divides the feature vector from the source language sentence and generates the normalization expression.

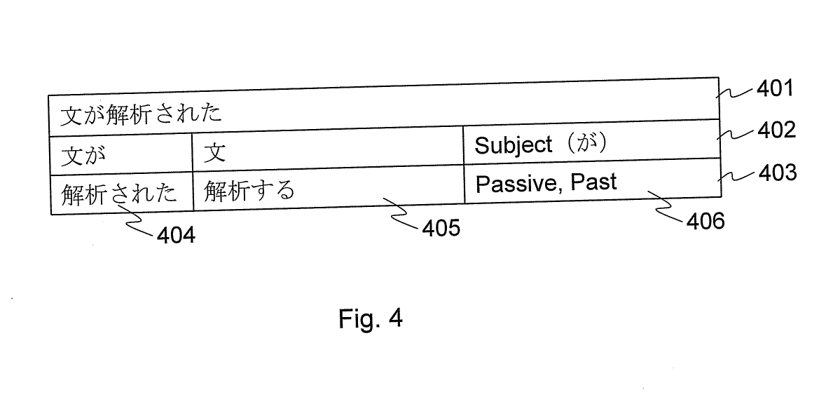

When a Japanese source expression 401 “ [symbol] (A sentence was analyzed.)” shown in FIG. 4 is inputted, the unit 103 generates a normalization expression 405 “ [symbol] (analyze)” and a feature vector 406 “Passive, Past” shown in row 403.

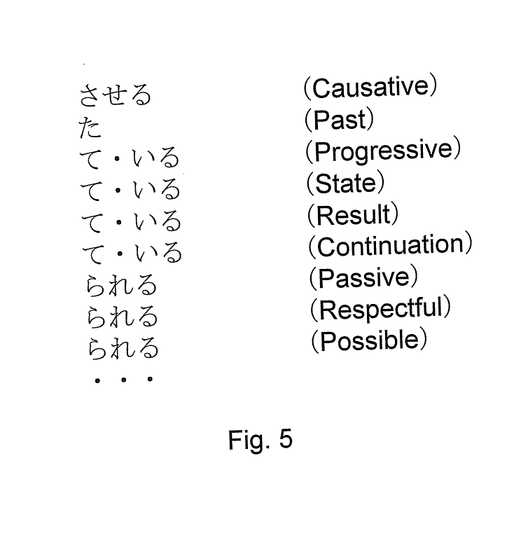

In this embodiment, the feature vector is extracted based on a morpheme dictionary and syntax information shown in FIG. 5. For example, a source expression 404 “ [symbol] (was analyzed)” is analyzed to “ [symbol] (analyze) • [symbol] (passive voice) • [symbol] (past tense)” referring to the dictionary shown in FIG. 5, and is transformed into the normalization expression 405 “ [symbol] (analyze)” and the feature vector 406 “Passive, Past”.

The analysis and transformation technology can apply morpheme analysis, syntax analysis, etc. The morpheme analysis can be applied to conventional analysis methods based on connection cost, a statistical language model, etc. The syntax analysis can be applied to conventional analysis methods based on CYK method (Cocke-Younger-Kasami), general LR method (Left-to-right and Right-most Parsing), etc.

Furthermore, the unit 103 divides a source expression into predetermined phrase units. In this Japanese example, the phrase units are set clauses including at most one content word and zero or more functional words. The content word represents a word which can constitute a clause independently in Japanese language, for example a noun, a verb, an adjective, etc. The functional word is a concept different from and often opposite to the content word, and represents a word which can not constitute a clause independently in Japanese language, for example, a particle, an auxiliary verb, etc.

In the case of FIG. 4, the source expression 401 “ [symbol] (bun ga kaiseki sareta)” is outputted as two phrases including 402 “ [symbol] (bun ga)” and 403 “ [symbol] (kaiseki sareta)”.

When the unit 106 applies an entry (a normalization expression), a feature vector and an attribute character word, the unit 106 stores a rule of an expression (or generation) generated about an entry, as an attribute expression model.

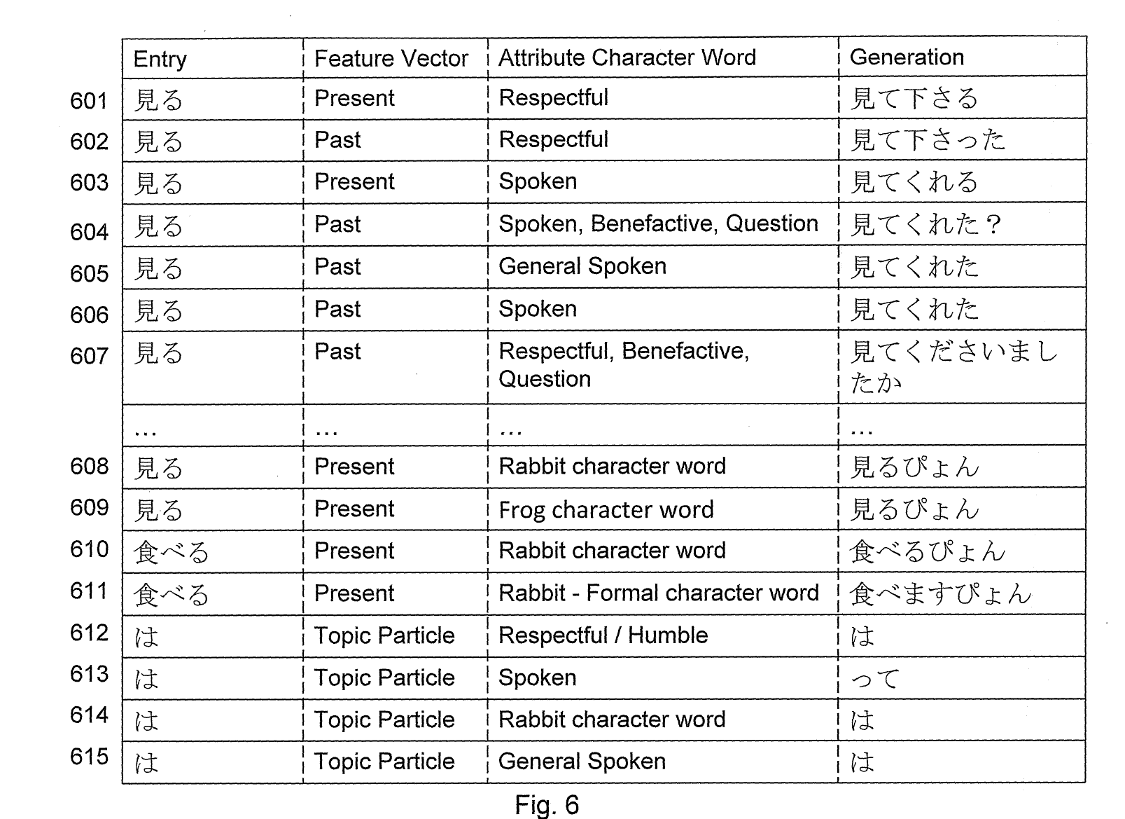

When a row 608 shown in FIG. 6 includes the entry “ [symbol] (miru)”, the feature vector “Present”, the “Rabbit character word (Speaking in a rabbit way)”, the row 608 represents a rule of generating the generation “ [symbol] (miru pyon)”. A Japanese expression “ [symbol] (pyon)” means a word which is spoken by Japanese young girls when the girls want to speak like a rabbit in Japan. The rules are stored by a normalization dictionary in the unit 106.

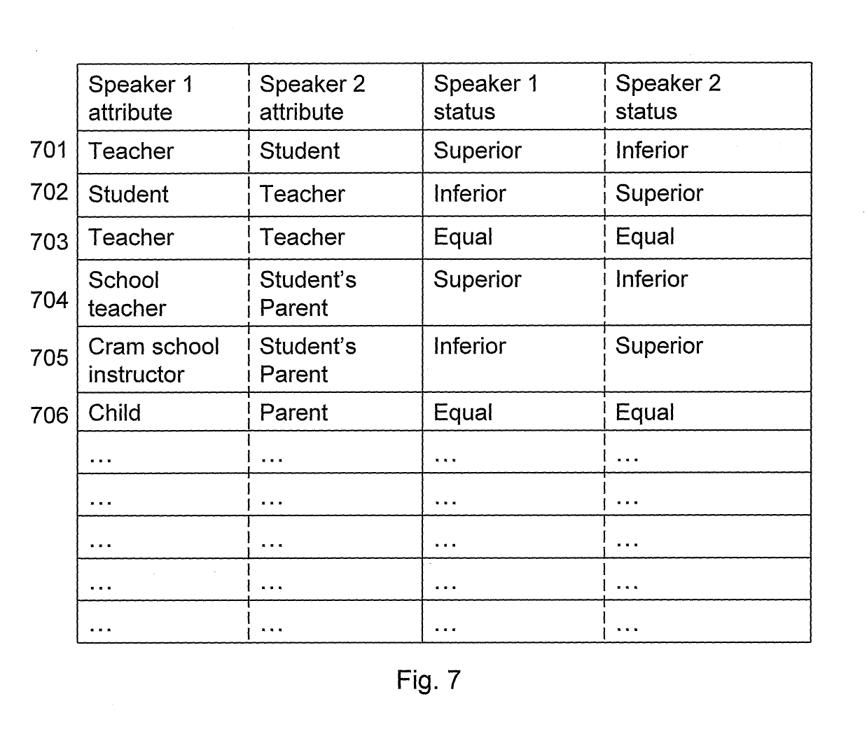

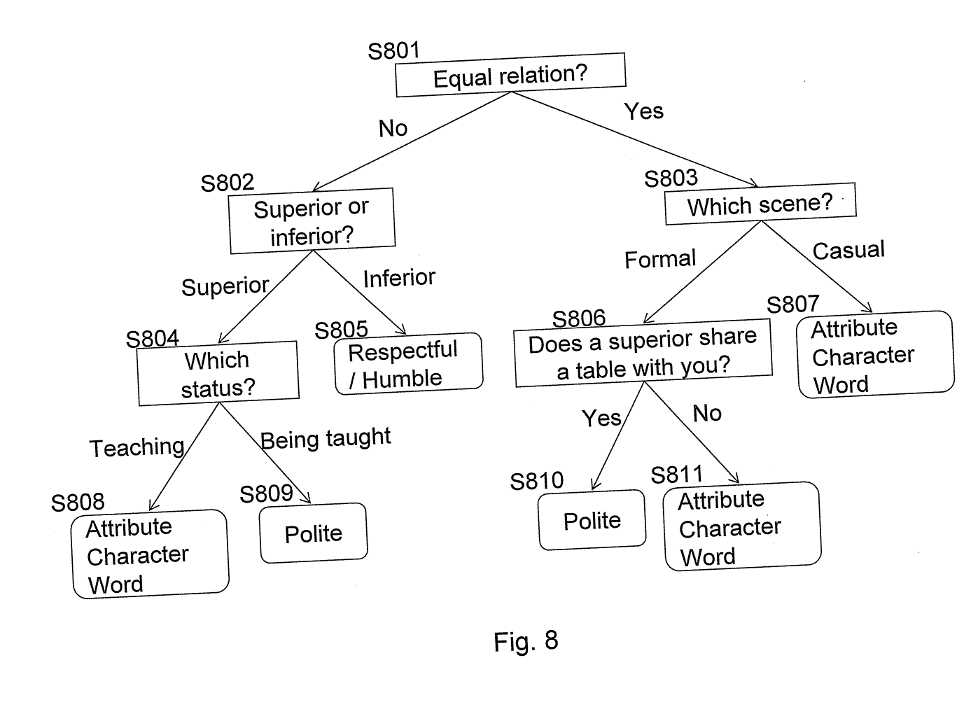

The unit 104 compares attributes of a plurality of speakers, and selects a priority attribute based on a dialogue scene and a relative speaker relationship between the speakers. In this embodiment, the unit 104 includes rules shown in FIG. 7 and a decision tree shown in FIG. 8, and adjusts the attributes of the speakers. FIG. 7 shows rules for deciding statuses of each speaker according to the speakers attributes. FIG. 8 shows a decision tree for deciding priority of attribute characteristic words according to the relative speaker relationship between the speakers.

In FIG. 7, a row 706 represents that when Speaker 1 with an attribute “Child” and Speaker 2 with an attribute “Parent” dialogue at the scene of “At home”, the statuses of Speaker 1 and Speaker 2 are “Equal”.

For example, when “a college student” dialogues with his/her parent “at home”, the process of deciding a priority of an attribute character word is explained referring to the decision tree shown in FIG. 8. The unit 102 detects speaker attributes “Youth, Student, Child” corresponding to profile information “College student” from a row 201 shown in FIG. 2, and detects a scene attribute “Casual” corresponding to scene information “At home” from a row 301 shown in FIG. 3. Therefore, when “a college student” dialogues with his/her parent “at home”, a relative relation “Equal” is selected (S801), a scene attribute “Casual” is selected (S803), and an “attribute character word” is selected (S807). The “attribute character word” is used for transforming a source expression spoken by the “College student” in the scene “At home”. The source expression is transformed by using the attribute character word “Spoken language” in row 201 of FIG. 2.

When speaker attributes of speakers in a dialogue are the same, the unit 104 calls the unit 109. The unit 109 avoids overlap between the speaker attributes by making, the difference between the speaker attributes.

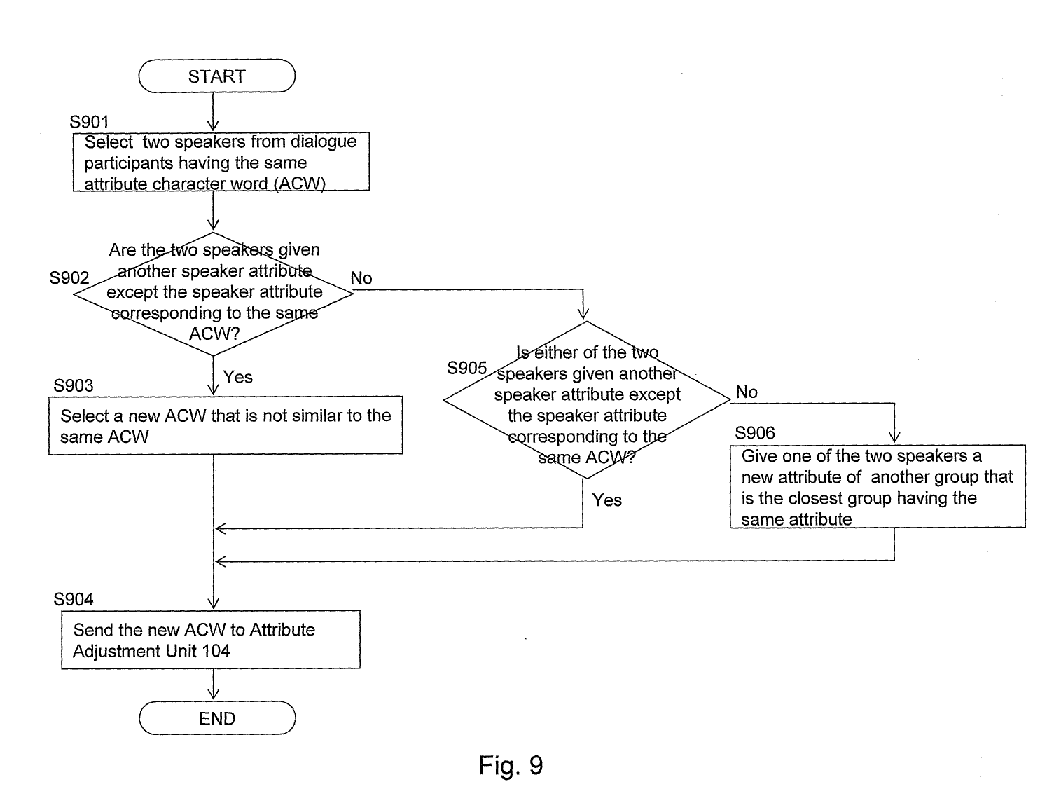

FIG. 9 illustrates a flowchart of avoiding overlap between the attribute characteristic words when each attribute characteristic word of the speakers is the same. The unit 109 selects two speakers from dialogue participants having the same attribute character word, and receives profile information of the two speakers from the unit 104 (S901). The unit 109 estimates whether the two speakers are given another speaker attribute except the speaker attribute corresponding to the same attribute character word.

When the two speakers are given the other speaker attribute (“Yes” of S902), the unit 109 replaces the same attribute character word with the new attribute character word that is not similar to the same attribute character word (S903). The unit 109 sends the replaced attribute character word to the unit 104, and end the process (S904).

On the other hand, when the two speakers are not given the other speaker attribute (“No” of S902), it is estimated whether either of the two speakers are given another speaker attribute except the speaker attribute corresponding to the same attribute character word (S905). And when either of the two speakers is given the other speaker attribute (“Yes” of S905), the other speaker attribute is set to an attribute character word and the process goes to S904.

When the process goes to “No” in S905, one of the two speakers is given a new attribute of another group having the same attribute (S906) and the process goes to S904.

The unit 105 transforms speaker's source expressions, based on the speaker attribute adjusted by the unit 104 and referring to the normalization dictionary stored by the unit 106.

For example, when a source expression “ [symbol] [symbol] ? (me-ru ha mou mimashitaka)” spoken by a speaker whose attribute character word is “Spoken” is transformed by an attribute character word “Spoken”, “ [symbol] (ha)” is transformed into “ [symbol] (ltute)” by row 613 of FIG. 6. And an entry “ [symbol] (miru)”, a feature vector “Past” and an attribute character word “Spoken” in row 604 is transformed into “ [symbol] (mite kureta)”.

The unit 107 outputs an expression transformed by the unit 105. The unit can be image-output by display unit, print-output by printer unit, speech-output by speech synthesis unit, etc.

The unit 108 receives a source expression inputted by the unit 101, a feature vector and an attribute character word detected by the unit 102, and an entry of a normalization expression that the source expression is processed by the unit 103, and matches the source expression, the feature vector, the attribute character word, and the entry. Then the unit 108 extracts the source expression, the feature vector, the attribute character word, and the entry as a new attribute expression model and registers the new model to the unit 106.

Furthermore, before the new attribute expression model is registered to the unit 106, the unit 108 includes other content word entries with the same part of speech, to expand the unit 108 itself.

At this time, when the unit 106 already stores the same entry and generation as the new expanded attribute expression model, if the new expanded attribute expression model is the spread attribute expression model, it is overwritten, or if it is not, it is not registered. Therefore the attribute expression model for real cases is gathered.

In this embodiment, a single entry and its transformation is explained. Although not so limited, an attribute expression model can be expanded by transforming syntactic and semantic structure, for example modification structure, syntax structure, etc. For example, an executing transfer method that is commonly used in machine translation in a monolingual environment can expand the process for a single entry as transformation depending on a structure.

In this embodiment, the attribute expression model stored by the unit 106 is not given a priority, extraction frequency in the unit 108 and application frequency in the unit 105 can transform the priority and delete the lower use frequency attribute expression model.

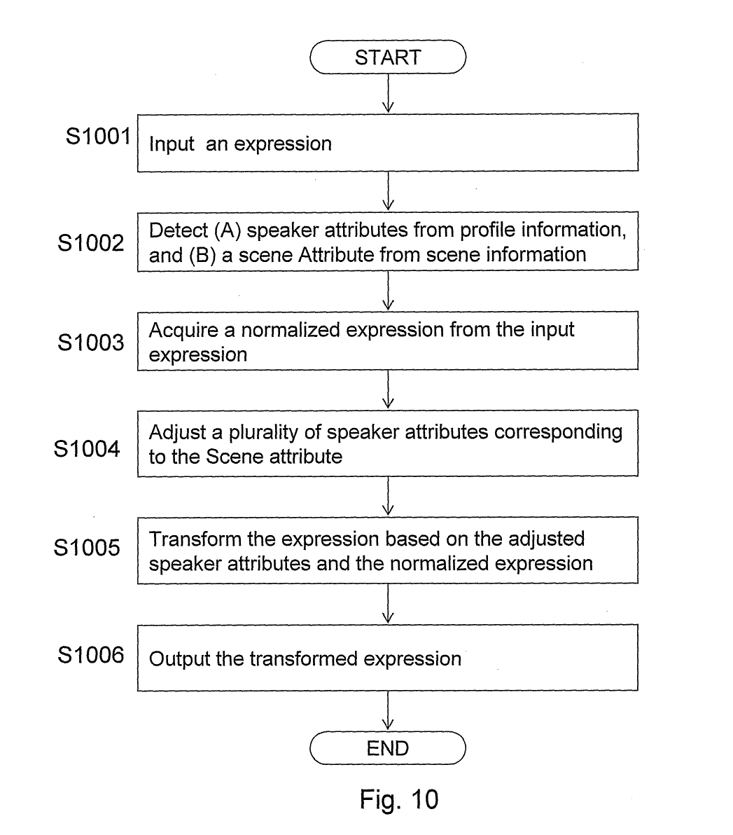

FIG. 10 illustrates a flow chart of applying an attribute expression model of an expression transformation apparatus. The unit 101 inputs a source expression and speaker profile information (S1001). The unit 102 detects a speaker attribute from the profile information and detects a scene attribute from scene information of a dialogue (S1002). The unit 103 acquires a normalization expression from the inputted source expression (S1003). The unit 104 adjusts a plurality of speaker attributes from speaker profile information (S1004). The unit 105 transforms the source expression by using the speaker attribute and the normalization expression adjusted by the unit 104 (S1005). The unit 107 outputs the expression transformed by the unit (S1006).

### First Example

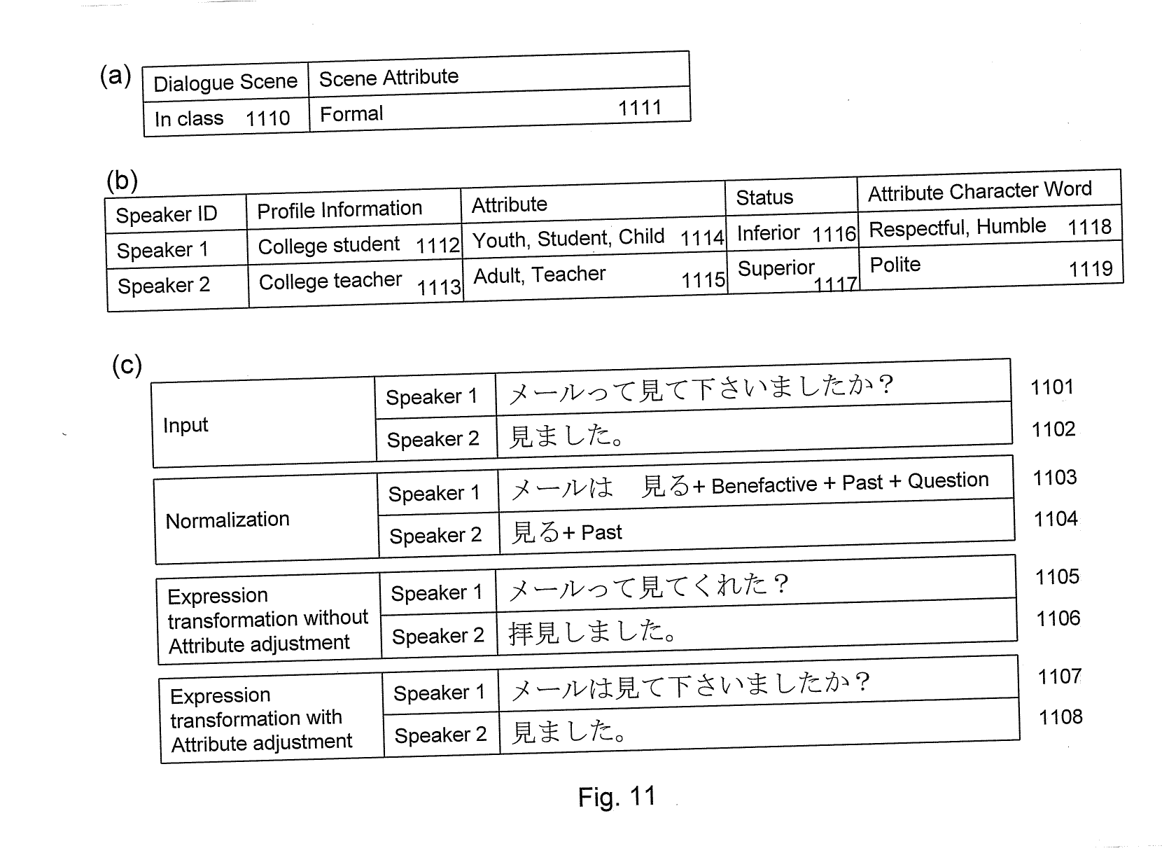

FIG. 11 shows the first example of applying attribute expression models. This example is explained referring to FIG. 10.

The first example is an example that Speaker 1 “College student” and Speaker 2 “College teacher” dialogue at the scene of “In class”.

The unit 101 receives a dialogue of Speaker 1 “ [symbol] [symbol] ? (me-ru ltute mite kudasai mashitaka?; see 1101 of FIG. 11(c))” and a dialogue of Speaker 2 “ [symbol] (mi mashita; see 1102 of FIG. 11(c))” (S1001).

The unit 102 detects speaker attributes of “College student” and “College teacher” from the speaker attribute table shown in FIG. 2 (S1002).

In this example, the speaker attributes “Youth, Student, Child” corresponding to the profile information “College student” is acquired from the rule 201 of FIG. 2. On the other hand, the speaker attributes “Adult, Teacher” corresponding to the profile information “College teacher” is acquired from the rule 202.

Furthermore, the scene attribute “Formal” corresponding to the scene information “In class” is detected from the rule 302 of FIG. 3.

The unit 103 normalizes the source expression of Speaker 1 “ [symbol] [symbol] [symbol] ? (me-ru ltute mite kudasai mashita ka?; see 1101 of FIG. 11(c))” inputted by the unit 101. In the source expression 1101, the unit 103 replaces “ [symbol] (ltute)” with “ [symbol] (wa)” and “ [symbol] (mite kudasai mashita)” with “ [symbol] (miru)”. In the result, the normalization expression 1103 that represents the entries “ [symbol] (me-ru ha) [symbol] (miru)” and the feature vector “Benefactive+Past+Question” are acquired. In a similar way, the unit 103 acquires the normalization expression 1104 that represents the entry “ [symbol] (miru)” and the feature vector “Past”, from the dialogue 1102 of Speaker 2 “ [symbol] (mimashita)”.

The unit 104 detects statuses of the speakers from the rules shown in FIG. 7. When profile information of the speakers are “College student” and “College teacher”, the rule 702 of FIG. 7 is applied. Therefore, the status of “College student” is “Inferior” (1116) and the status of “College teacher” is “Superior” (1117).

The unit 104 then determines, based on the decision tree shown in FIG. 8, a priority of attribute character words that is used when each speaker's expression is transformed.

The following example shows the case where the decision tree shown in FIG. 8 is used with respect to Speaker 1 shown in FIGS. 11. 1116 and 1117 shown in FIG. 11 show Speaker 1 is not equal to Speaker 2 (“No” of S801 shown in FIG. 8), and the process goes to S802. Then the status of Speaker 1 is “Inferior” (1116 shown in FIG. 11) and the process goes to S805. S805 gives priority to “Respectful, Humble” (1118 shown in FIG. 11) in case of transforming the expression of Speaker 1. In a similar way, S808 gives priority to “Polite” (1119 shown in FIG. 11) in case of transforming the expression of Speaker 2.

The unit 105 transforms a source expression of a speaker according to the attribute character word set by the unit 104 (S1005). In the example shown in FIG. 11, the unit 105 refers the normalization dictionary shown in FIG. 6, transforms a part “ [symbol] (miru)” of the normalization expression 1103 “ [symbol] (me-ru ha) [symbol] (miru)+Benefactive+Past+Question” into “ [symbol] [symbol] (mite kudasai masita ka)” according to the rule 607 shown in FIG. 6, and acquires the expression 1107 “ [symbol] [symbol] ? (me-ru ha mite kudasai masita ka)”.

If the unit 104 does NOT exist, the expression is transformed according to the attribute character word “Spoken language” of “College student” shown in the rule 201 of FIG. 2. Then the rule 604 and 613 is applied in case of transforming the normalization expression 1103. This case transforms into the expression transformation WITHOUT attribute adjustment 1105 “ [symbol] [symbol] ? (me-ru ltute mite kureta?)”. This case is inadequacy on the expression of “College student” dialogue to “College teacher” at the scene of “In class”.

The unit 107 outputs the expression transformation WITH attribute adjustment 1107 “ [symbol] [symbol] ? (me-ru ha mite kudasai mashita ka)” (S1006).

In the first example, the unit 104 adjusts an attribute based on a speaker attribute and a scene attribute.

However, a scene attribute is not essential and the unit 104 can adjust an attribute based only on a speaker attribute.

The effective case of adjusting an attribute based on not only a speaker attribute but also a scene attribute is explained hereinafter. When a dialogue between familiar professors is conducted at public scene for example symposium and the problem of transforming to “Spoken language” at the scene attribute of “Formal” is occurred. But the effective case can avoid the problem, because of controlling not only a speaker attribute, for example “Superior, Inferior”, but also controlling a scene attribute “Formal”.

### Second Example

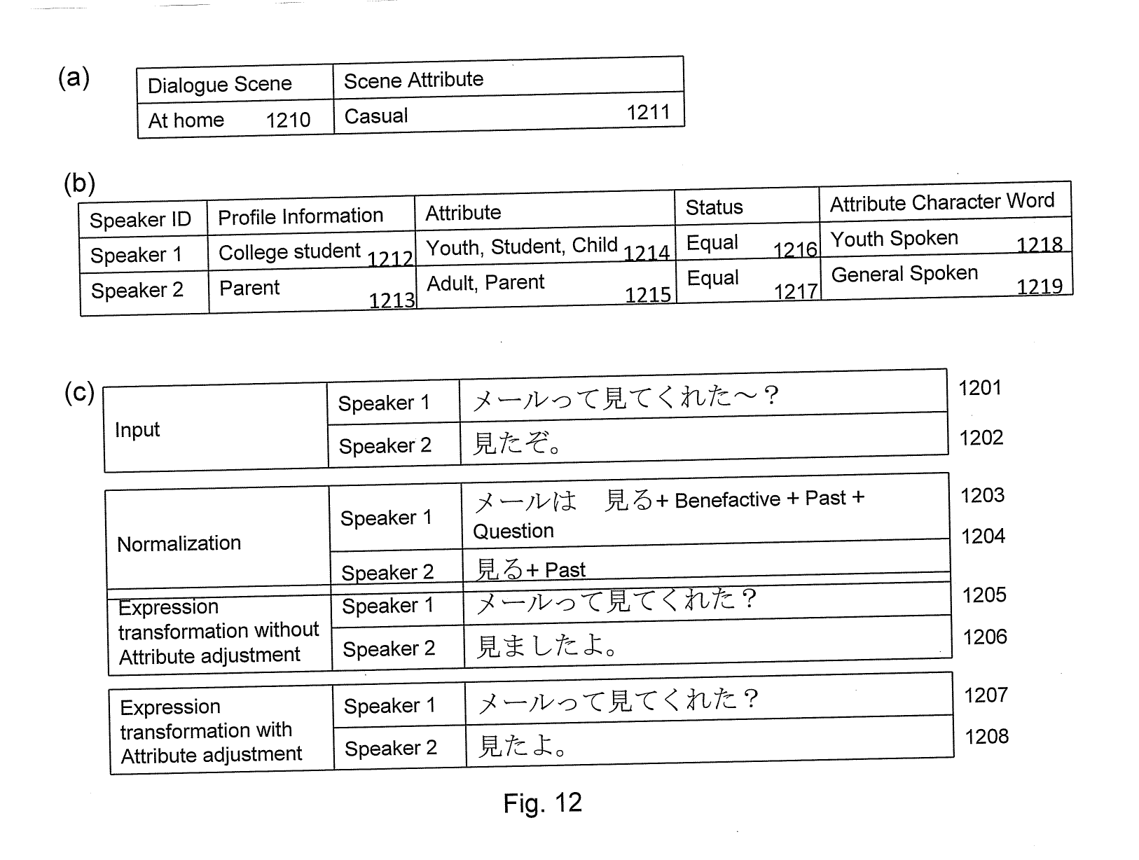

FIG. 12 shows the second example of applying attribute expression models. This example is explained referring to FIG. 10.

The second example is an example that Speaker 1 “College student” and Speaker 2 “Parent” dialogue at the scene of “At home”. The unit 101 inputs source expressions 1201 and 1202 shown in FIG. 12 (S1001 shown in FIG. 10).

The unit 102 detects speaker attributes of “College student” and “Parent” according to the speaker attribute table shown in FIG. 2 (S1003). This example gives attributes “Youth, Student, Child” to “College student” and attributes “Adult, Parent, Polite” to “Parent” according to the rules 201 and 203 shown in FIG. 2.

Then the unit 102 detects a scene attribute “Casual” from a scene information “At home” according to the rule 301 shown in FIG. 3.

The unit 103 normalizes the input 1201 “ [symbol] [symbol] ? (me-ru ltute mite kureta˜?)”. The input 1201 is replaced by the unit 103 from “ [symbol] (ltute)” to “ [symbol] (ha)” and from “ [symbol] (mite kureta˜)” to “ [symbol] (miru)”. Therefore the unit 103 acquires the normalization 1203 “ [symbol] +Benefactive+Past+Question”. In a similar way, the unit 103 normalizes the input 1202 “ [symbol] (mita zo.)” to the normalization 1204 “ [symbol] +Past”.

The unit 104 detects statuses of each speaker according to the rules shown in FIG. 7. “College student” and “Parent” shown in FIG. 12 is applied to the rule 706 shown in FIG. 7. The status of “College student” is “Equal” (1216). The status of “parent” is “Equal” (1217).

Then the unit 104 determines, based on the decision tree shown in FIG. 8, a priority of attribute character words that is used when each speaker's expression is transformed. The following example shows the case where the decision tree shown in FIG. 8 is used for Speaker 1 shown in FIG. 12. The status of Speaker 1 is “Equal” (1216), and S801 shown in FIG. 8 goes to S803. The Scene attribute is “Casual” (1211), and S803 goes to S807. Therefore the priority attribute of transforming the source expression of Speaker 1 “College student”, is an attribute character word, that is to say, “Spoken language” shown in the rule 201 of FIG. 2. In a similar way, the priority attribute of Speaker 2 “Parent” is “Polite”.

The unit 105 transforms a source expression of a speaker according to the priority attribute set by the unit 104. In the example shown in FIG. 12, the unit 105 refers the normalization dictionary shown in FIG. 6, and transforms a part “ [symbol] (ha)” of the normalization expression 1203 “ [symbol] (me-ru ha) [symbol] (miru)+Benefactive+Past+Question” into “ [symbol] [symbol] (ltute)” according to the rule 613 shown in FIG. 6, and another part “ [symbol] (miru)” into “ [symbol] [symbol] ? (mite kureta?)” according to the rule 604. Therefore the unit 105 acquires the expression 1207 “ [symbol] [symbol] ? (me-ru ltute mite kureta?)”.

The unit 107 outputs the expression 1207 “ [symbol] [symbol] (me-ru ltute mite kureta?)” transformed by the unit 105.

In FIG. 11 and FIG. 12, the same normalization expression “ [symbol] (me-ru ha) [symbol] (miru)+Benefactive+Past+Question” is transformed corresponding to another person of a dialogue. In FIG. 11, 1107 “ [symbol] [symbol] ? (me-ru ha mite kudasai masita ka?)” is transformed to, according to the other speaker “College teacher”. In FIG. 12, 1207 “ [symbol] [symbol] ? (me-ru ltute mite kureta?)” is transformed to, according to the other speaker “Parent”. In this way, one advantage of this embodiment is to transform a dialogue of the speaker having the same attribute into an adequate expression, according to the other speaker and the scene.

### Third Example

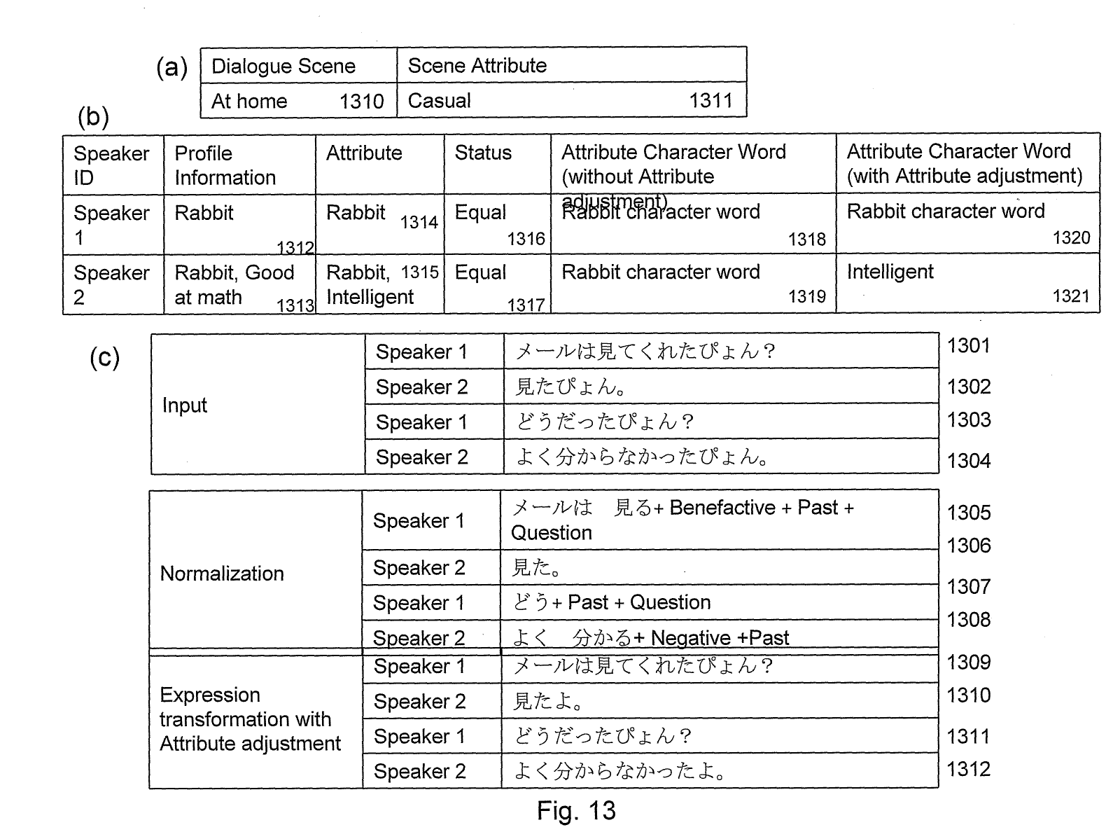

FIG. 13 shows the third example of applying attribute expression models. This example is explained referring to FIG. 9.

The third example is an example that Speaker 1 “Rabbit” and Speaker 2 “Rabbit, Good at math” dialogue at the scene of “At home”.

In this case, Speaker 1 and Speaker 2 have the same speaker attribute “Rabbit” and the same speaker attribute “Rabbit” overlaps. Either Speaker 1 or Speaker 2 abandons the speaker attribute “Rabbit”, selects another speaker attribute, and transforms the source expression according to an attribute character word corresponding to the selected speaker attribute.

When one of speaker attributes of speakers is the same, the unit 104 calls the unit 109. The unit 109 makes difference between attributes of speakers who have the same attribute. The processes of the unit 109 are already explained according to FIG. 9.

Hereinafter, the flowchart shown FIG. 9 of avoiding overlap between the attribute characteristic words is explained, when each attribute characteristic word of the speakers is the same, for example FIG. 13.

In FIG. 13, Speaker 1 and Speaker 2 have the same attribute “Rabbit” (1318, 1319), if this goes on, Expressions of Speaker 1 and Speaker 2 is transformed to “Rabbit Character word”.

When Speaker 1 and Speaker 2 have the same attribute character word, the unit 104 gives all of the attributes of Speaker 1 and Speaker 2 to the unit 109. The unit 109 avoids overlap between the attribute character words of Speaker 1 and Speaker 2 according to FIG. 9.

The unit 109 receives all the profile information of Speaker 1 and Speaker 2 who have the same attribute character word from the unit 104 (S901). The profile information of Speaker 1 is “Rabbit”, and the profile information of Speaker 2 is “Rabbit, Good at math”. S902 determines whether the speakers are given another profile information except the profile information corresponding to the overlapped attribute character word.

In this example. Speaker 2 has another speaker profile “Good at math” except the overlapped speaker profile “Rabbit” and the process goes to S903. S903 refers to the row 205 of FIG. 2, acquires the speaker attribute and the attribute character word “Intelligent” from the profile information “Good at mathematics”, and goes to S904. S904 replaces the attribute character word of Speaker 2 to “Intelligent” (1321 of FIG. 13), send “Intelligent” to the unit 104, and the process is end.

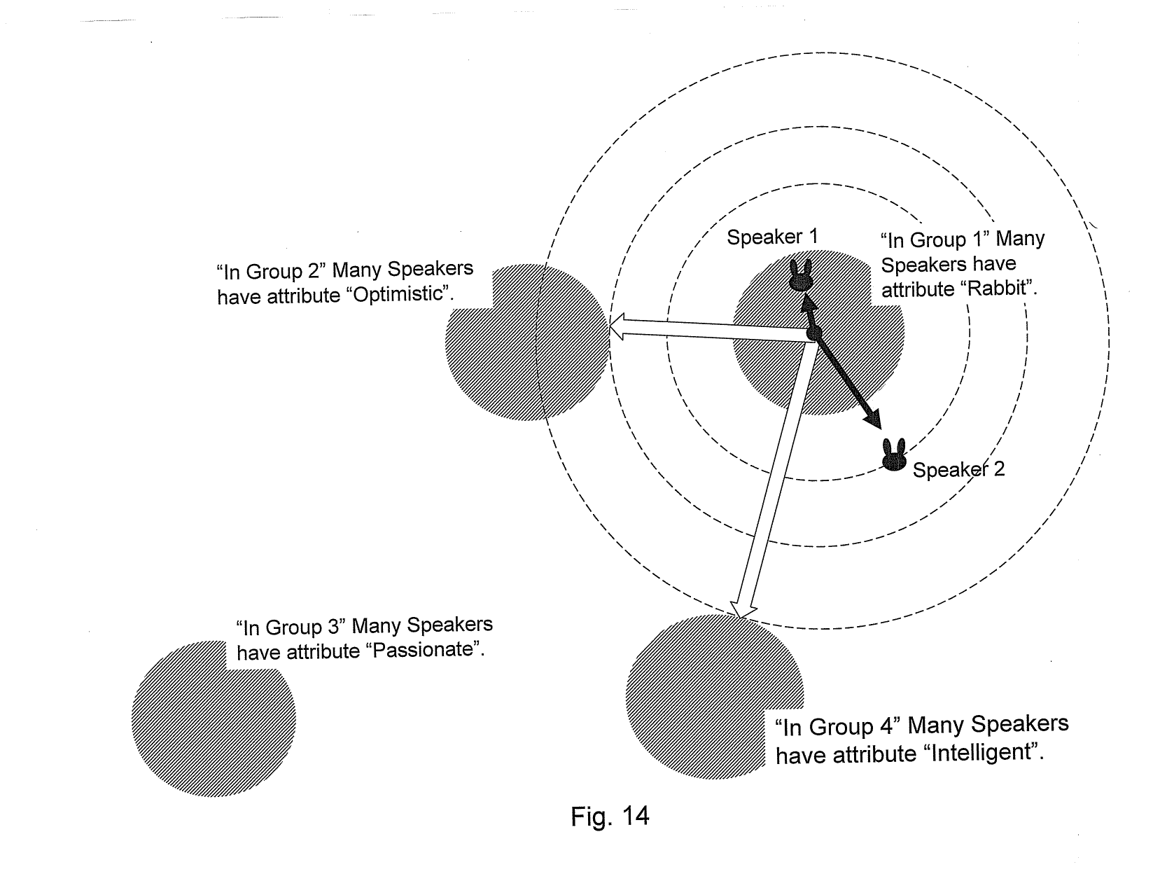

FIG. 14 shows the case in which each attribute characteristic word of the speakers is the same and S906 in FIG. 9 is applied. When speaker attributes represent abstract attributes for example “Rabbit”, “Optimistic”, “Passionate” and “Intelligent”, the overlap of the attribute character words of Speaker 1 and Speaker 2 can occur. For example, when it is supposed that (1) Group 1 where many speakers have attribute “Rabbit”, (2) Group 2 where many speakers have attribute “Optimistic”, (3) Group 3 where many speakers have attribute “Passionate” and (4) Group 4 where many speakers have attribute “Intelligent”, the overlap can occur in the case when Speaker 1 “Rabbit and Optimistic” and Speaker 2 “Rabbit and Intelligent” are closer in (1) Group 1. Therefore the method of the third example is effective.

When Speaker 1 and Speaker 2 do not recognize each ID in Social Networking Service (SNS), the third example is effective. Furthermore this example is more effective in the case when Speakers include three or more people.

(Attribute Expression Model Constitution Apparatus 111)

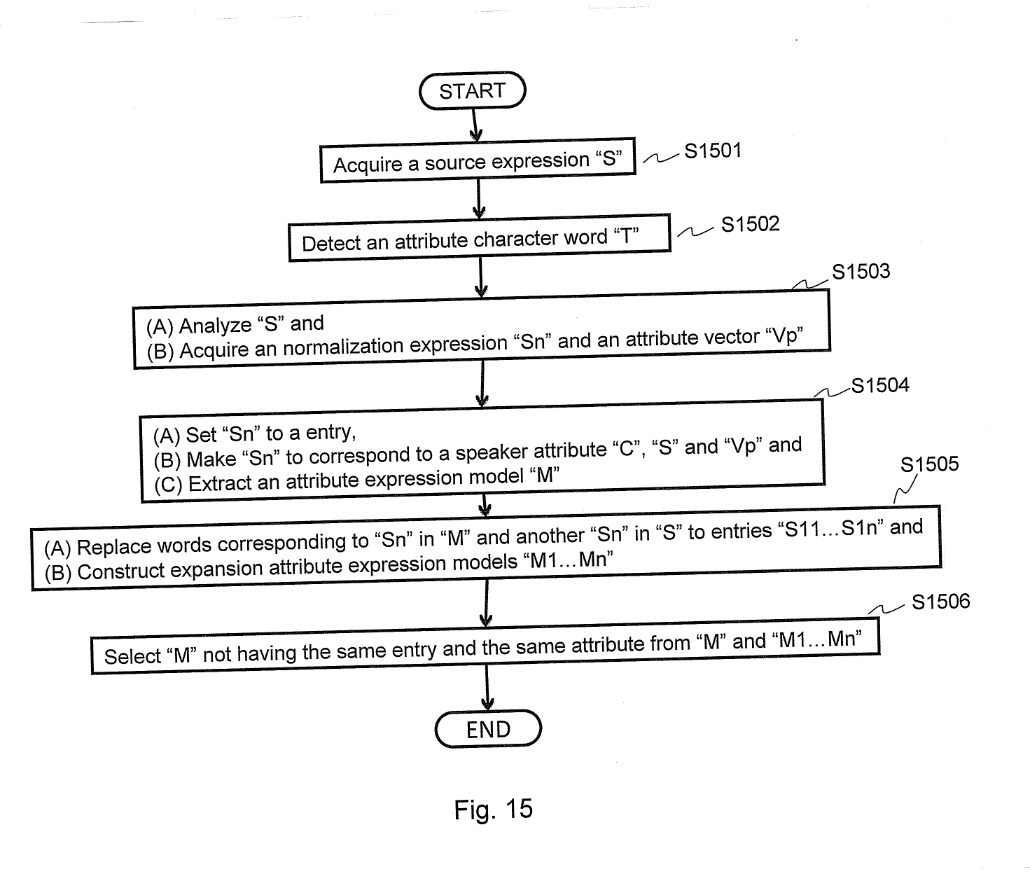

FIG. 15 illustrates a flow chart of the operation of an attribute expression model constitution apparatus 111.

The unit 101 acquires a source expression “S” (S1501). The unit 102 detects an attribute character word “T” (S1502). The unit 103 analyzes the source expression “S” and acquires a normalization expression “Sn” and an attribute vector “Vp” (S1503).

The unit 108 set the normalization expression “Sn” to an entry, makes “Sn” correspond to a speaker attribute “C”, the source expression “S” and an attribute vector “Vp”, and extracts an attribute expression model “M” (S1504). Then the unit 108 replaces words corresponding to “Sn” in “M” and another “Sn” in “S” to entries “S11 . . . S1n” having the same part of speech, and contracts expansion attribute expression models “M1 . . . M2” (S1505).

The unit 108 selects “M” not having the same entry and the same attribute from “M” and “M1 . . . Mn” (S1506).

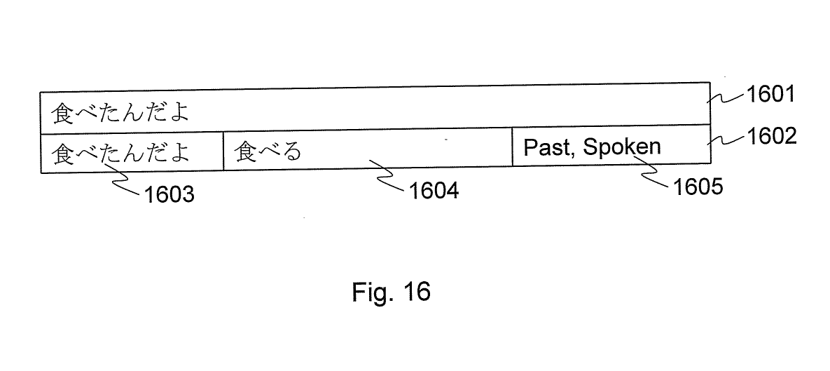

An example is explained hereinafter. It is supposed that the unit 101 inputs “ [symbol] [symbol] (tabe tan dayo)” as a source expression “S” (S1501). And it is supposed that the unit 102 acquires “Spoken” as an attribute character word “T” (S1502). The unit 103 analyzes the source expression “S” and acquires the normalization “Sn” “ [symbol] (taberu)” 1604 and the attribute vector “Vp” “Past and Spoken” 1605 shown in FIG. 16 (S1503).

The unit 108 sets Sn “ [symbol] (taberu)” to an entry and S “ [symbol] (babe tan dayo)” to a generation, makes these to correspond to T “Spoken” and Vp “Past and Spoken”, and extracts “M” (S1504). Therefore new inputted source expression and normalization expression can be corresponded to attribute vector and attribute character word, and attribute expression models corresponding to new attribute and input expression can be increasingly constructed.

If a part of speech of Sn “ [symbol] (taberu)” is “verb”. S1505 constructs expansion attribute expression models “M1 . . . Mn” by replacing an entry of “M” on the word having a part of speech “verb”.

For example, if a part of speech of “ [symbol] (miru)” is “verb”, Sn “ [symbol] (miru)” is set to an entry. And “ [symbol] (mitan dayo)” to which is replaced a word corresponding to an entry of a source expression with “ [symbol] (miru)”, is set to a generation. An expansion attribute expression model M0 is extracted by corresponding these to T “Spoken” and Vp “Passive, Past”.

In a similar way of “ [symbol] (hasiru)”, Sn “ [symbol] (hasiru)” is set to an entry. And “ [symbol] [symbol] (hashitta dayo)” to which is replaced a word corresponding to a direction word of a source expression with “ [symbol] (hashiru)”, is set to a generation. An expansion attribute expression model M1 is extracted by corresponding these to T “Spoken” and Vp “Passive, Past”. The model after M1 can be repeatedly extracted in a similar way.

S1506 selects “M” not having the same entry and the same attribute from “M” and “M1 . . . Mn” and stores it to the unit 106.

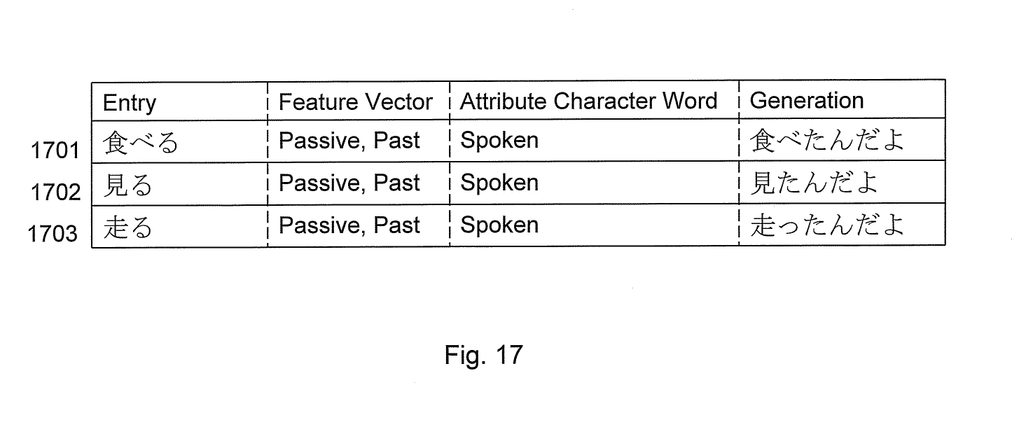

If there are three verbs, that is, an attribute expression model and an expansion attribute expression model shown in FIG. 17, for explaining simply, and the state of the unit 106 is similar to FIG. 6, the attribute expression models 1701 through 1703 are all registered, because the unit 106 do not store the attribute expression model having the same entry and the same attribute. Therefore the attribute transform model according to real-case can be stored.

The above processes increase and update the attribute expression model stored by the unit 106. Therefore, it is able to transform expression according to various attributes. That is to say, the expression transformation apparatus 110 increasingly stores the difference between input of various expressions and attributes and its normalization expression and can transform various expressions for new input expressions.

According to expression transformation apparatus of at least one embodiment described above, the apparatus is able to adjust attributes of speakers according to relative relationship between speakers, transform the input sentence of a speaker into adequate expression for another speaker and acquire the expression that is reflected the relative relationship between speakers.

While certain embodiments have been described, these embodiments have been presented by way of example only, and are not intended to limit the scope of the inventions.

For example, the output result of the apparatus 110 can be applied to an existing dialogue apparatus. The existing dialogue apparatus can be a speech dialogue apparatus and text-document style dialogue apparatus. In addition, the dialogue apparatus can be applied to an existing machine translation apparatus.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The flow charts of the embodiments illustrate methods and systems according to the embodiments. It will be understood that each block of the flowchart illustrations, and combinations of blocks in the flowchart illustrations, can be implemented by computer program instructions. These computer program instructions can be loaded onto a computer or other programmable apparatus to produce a machine, such that the instructions which execute on the computer or other programmable apparatus create means for implementing the functions specified in the flowchart block or blocks. These computer program instructions can also be stored in a non-transitory computer-readable memory that can direct a computer or other programmable apparatus to function in a particular manner, such that the instruction stored in the non-transitory computer-readable memory produce an article of manufacture including instruction means which implement the function specified in the flowchart block or blocks. The computer program instructions can also be loaded onto a computer or other programmable apparatus/device to cause a series of operational steps/acts to be performed on the computer or other programmable apparatus to produce a computer programmable apparatus/device which provides steps/acts for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An expression transformation apparatus comprising:
a processor communicatively coupled to a memory that stores computer-executable instructions, that executes or facilitates execution of computer-executable components, comprising;
an input unit configured to input a sentence of a first speaker as a source expression;
a detection unit configured to detect a speaker attribute representing a feature of the first speaker;
a normalization unit configured to transform the source expression to a normalization expression including an entry and a feature vector representing a grammatical function of the entry;
an adjustment unit configured to adjust the speaker attribute to a relative speaker relationship between the first speaker and a second speaker, based on another speaker attribute of the second speaker; and
a transformation unit configured to transform the normalization expression based on the relative speaker relationship.

2. The apparatus according to claim 1, wherein the detection unit detects a scene attribute representing a scene in which the source expression is inputted; and
the adjustment unit adjusts the speaker attribute to the relative speaker relationship, based on the scene attribute.

3. The apparatus according to claim 1, further comprising:
a storage unit configured to store a model transforming the source expression based on the speaker attribute.

4. The apparatus according to claim 3, wherein the storage unit stores the model transforming the source expression based on the scene attribute representing a scene in which the source expression is inputted.

5. The apparatus according to claim 1, further comprising:
an avoiding unit configured to avoid attribute character words overlapping when the attribute character words between the first speaker and the second speaker overlap.

6. An expression transformation method comprising:
inputting a sentence of a first speaker as a source expression;
detecting a speaker attribute representing a feature of the first speaker;
transforming the source expression to a normalization expression including an entry and a feature vector representing a grammatical function of the entry;
adjusting the speaker attribute to a relative speaker relationship between the first speaker and a second speaker, based on another speaker attribute of the second speaker; and
transforming the normalization expression based on the relative speaker relationship.

7. A computer program product having a non-transitory computer readable medium comprising programmed instructions for performing an expression transformation processing, wherein the instructions, when executed by a computer, cause the computer to perform:
inputting a sentence of a first speaker as a source expression;
detecting a speaker attribute representing a feature of the first speaker;
transforming the source expression to a normalization expression including an entry and a feature vector representing a grammatical function of the entry;
adjusting the speaker attribute to a relative speaker relationship between the first speaker and a second speaker, based on another speaker attribute of the second speaker; and
transforming the normalization expression based on the relative speaker relationship.
